(19) United States
(12) Patent Application Publication
(10) Pub. No.: US 2012/0120117 A1
(43) Pub. Date: May 17, 2012

(54) DRIVING METHOD OF HALF-SOURCE-DRIVING (HSD) DISPLAY DEVICE

(75) Inventors: Shu-Huan HSIEH, Hsin-Chu (TW); Fu-Yuan Liou, Hsin-Chu (TW); Chung-Lung Li, Hsin-Chu (TW)

(73) Assignee: AU OPTRONICS CORP., HSINCHU (TW)

(21) Appl. No.: 13/101,441

(22) Filed: May 5, 2011

(30) Foreign Application Priority Data
Nov. 12, 2010 (TW) 099138954

(51) Int. Cl. G09G 5/10

(52) U.S. Cl. 345/690

(57) ABSTRACT

A HSD display device is adapted to receive data from a signal source and includes multiple pixel sets. Each pixel sets includes first pixel and second pixel. The first pixel is electrically coupled to a first data line and a first gate line. The second pixel is electrically coupled to the first pixel and a second gate line. The first gate line and the second gate line respectively are for controlling the first pixel and the second pixel whether to receive the data. In a driving method of the HSD display device, a common voltage is provided to the first and second pixels, and the common voltage is modulated to have two different voltage levels at a same side of a data central voltage. The data central voltage is an average of data voltages with different polarities from the signal source for displaying a same gray level.

### FIELD OF THE INVENTION

The present invention relates to the display field, and more particularly to a driving method of a half-source-driving (HSD) display device.

### BACKGROUND OF THE INVENTION

With the development of science and technology, flat panel display devices (e.g., liquid crystal display devices) have many advantages of high display quality, small volume, light weight and wide application range and thus are widely used in consumer electronics products such as mobile phones, laptop computers, desktop computers and televisions, etc. Moreover, the liquid crystal display devices have evolved into a mainstream display in place of cathode ray tube (CRT) displays.

In the prior art, a HSD display device with half-source-driving structure has been proposed to reduce the amount of required data lines for improving the competitive strength in cost. In particular, the conventional HSD display device includes multiple pixel sets. Each of the pixel sets includes a first pixel and a second pixel. The first pixel is electrically coupled to a data line and a gate line, and thereby is controlled by the gate line whether to receive display data from the data line. The second pixel is electrically coupled to the data line through the first pixel and further electrically coupled to another adjacent gate line, and thereby is controlled by the two adjacent gate lines whether to receive the display data from the data line.

However, when the HSD display device is operated to display an image, since the second pixel has an extra feed through effect relative to the first pixel and generally the feed through voltage of the second pixel is almost two times of the feed through voltage of the first pixel, so that a dynamic mura phenomenon occurs.

### SUMMARY OF THE INVENTION

Therefore, the present invention is directed to a driving method of a HSD display device, which can effectively suppress the occurrence of the dynamic mura phenomenon during image displaying in the prior art.

More specifically, a driving method in accordance with an embodiment of the present invention is adapted for a HSD display device. The HSD display device is adapted to receive data from a signal source and includes multiple pixel sets. Each of the pixel sets includes a first pixel and a second pixel. The first pixel is electrically coupled to a first data line and a first gate line. The second pixel is electrically coupled to the first pixel and a second gate line. The first gate line is for controlling the first pixel whether to receive the data from the first data line. The second gate line is for controlling the second pixel whether to receive the data from the first data line. In the driving method, a common voltage is provided to the first pixel and the second pixel. The common voltage is modulated to have two different voltage levels at a same side of a data central voltage. The data central voltage is an average value of data voltages with different polarities provided from the signal source for displaying a same gray level.

In one embodiment, the common voltage is kept at one side of the data central voltage, or goes back and forth at two sides of the data central voltage instead. In the situation of the common voltage goes back and forth at two sides of the data central voltage, the common voltage has two different voltage levels at each side of the data central voltage during the HSD display device displaying a single frame; or the common voltage has two different voltage levels at each side of the data central voltage during the HSD display device continuously displaying multiple frames, while only has one of the two different voltage levels at each side of the data central voltage during the HSD display device displaying any one of the frames.

In one embodiment, in the above driving method, the second gate line is enabled in a first time period, and then is disabled in a second time period immediately following the first time period. The second gate line is enabled again in a third time period immediately following the second time period. The first gate line is enabled in a former fourth time period of the third time period, and then is disabled in a latter fifth time period of the third time period immediately following the fourth time period. Subsequently, the first gate line is enabled again in a sixth time period immediately following the third time period.

Preferably, the first time period has a time length same as that of the fourth time period. The third time period is equally divided into the fourth time period and the fifth time period. A switching period of the two different voltage levels is the same as a time length of the third time period during enabling the common voltage to have two different voltage levels at a same side of the data central voltage.

In summary, in the various embodiments of the present invention, by enabling the common voltage to have two different voltage levels at a same side of the data central voltage to thereby compensate the extra feed through effect applied to the second pixel, so that the feed through voltage of the second pixel in the present invention is substantially equal to the feed through voltage of the first pixel. Accordingly, the occurrence of dynamic mura phenomenon during the HSD display device displaying images in the prior art can be effectively suppressed.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1(A) and 1(B) show schematic polarity arrangements of multiple pixels during a HSD display device with column inversion of a first embodiment of the present invention displaying a frame F1 and a frame F2.

FIG. 2 shows direct current (DC) common voltage driving processes during displaying the frame F1 in FIG. 1(A).

FIG. 3 shows DC common voltage driving processes during displaying the frame F2 in FIG. 1(B).

FIGS. 4(A) and 4(B) show schematic polarity arrangements of multiple pixels during a HSD display device with 2-dot inversion of a second embodiment of the present invention displaying a frame F1 and a frame F2.

FIG. 5 shows DC common voltage driving processes during displaying the frame F1 in FIG. 4(A).

FIG. 6 shows DC common voltage driving processes during displaying the frame F2 in FIG. 4(B).

FIGS. 7(A) and 7(B) show schematic polarity arrangements of multiple pixels during a HSD display device with dot inversion of a third embodiment of the present invention displaying a frame F1 and a frame F2.

FIG. 8 shows DC common voltage driving processes during displaying the frame F1 in FIG. 7(A).

FIG. 9 shows DC common voltage driving processes during displaying the frame F2 in FIG. 7(B).

FIGS. 10(A) and 10(B) show schematic polarity arrangements of multiple pixels during a HSD display device with row inversion of a fourth embodiment of the present invention displaying a frame F1 and a frame F2.

FIG. 11 shows DC common voltage driving processes during displaying the frame F1 in FIG. 10(A).

FIG. 12 shows DC common voltage driving processes during displaying the frame F2 in FIG. 10(B).

FIGS. 13(A) and 13(B) show schematic polarity arrangements of multiple pixels during a HSD display device with frame inversion of a fifth embodiment of the present invention displaying a frame F1 and a frame F2.

FIG. 14 shows DC common voltage driving processes during displaying the frame F1 in FIG. 13(A).

FIG. 15 shows DC common voltage driving processes during displaying the frame F2 in FIG. 13(B).

FIGS. 16(A) and 16(B) show schematic polarity arrangements of multiple pixels during a HSD display device with column inversion of a sixth embodiment of the present invention displaying a frame F1 and a frame F2.

FIG. 17 shows alternating current (AC) common voltage driving processes during displaying the frame F1 in FIG. 16(A).

FIG. 18 shows AC common voltage driving processes during displaying the frame F2 in FIG. 16(B).

FIGS. 19(A) and 19(B) show schematic polarity arrangements of multiple pixels during a HSD display device with dot inversion of a seventh embodiment of the present invention displaying a frame F1 and a frame F2.

FIG. 20 shows AC common voltage driving processes during displaying the frame F1 in FIG. 19(A).

FIG. 21 shows AC common voltage driving processes during displaying the frame F2 in FIG. 19(B).

FIGS. 22(A) and 22(B) show schematic polarity arrangements of multiple pixels during a HSD display device with row inversion of a eighth embodiment of the present invention displaying a frame F1 and a frame F2.

FIG. 23 shows AC common voltage driving processes during displaying the frame F1 in FIG. 22(A).

FIG. 24 shows AC common voltage driving processes during displaying the frame F2 in FIG. 22(B).

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

### First Embodiment

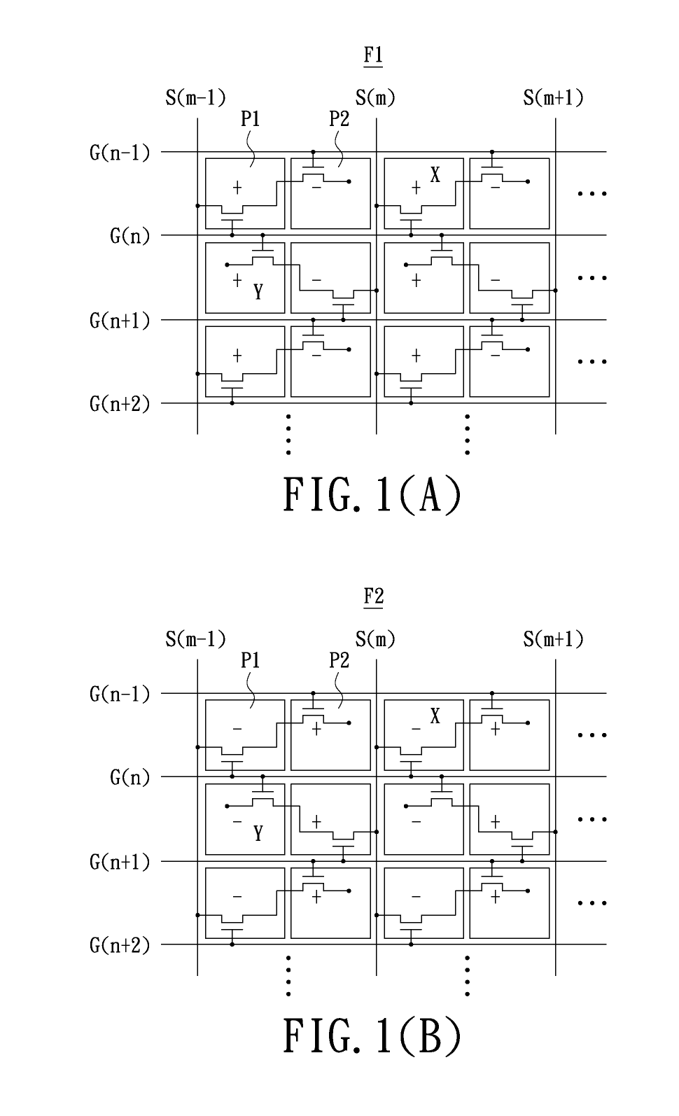

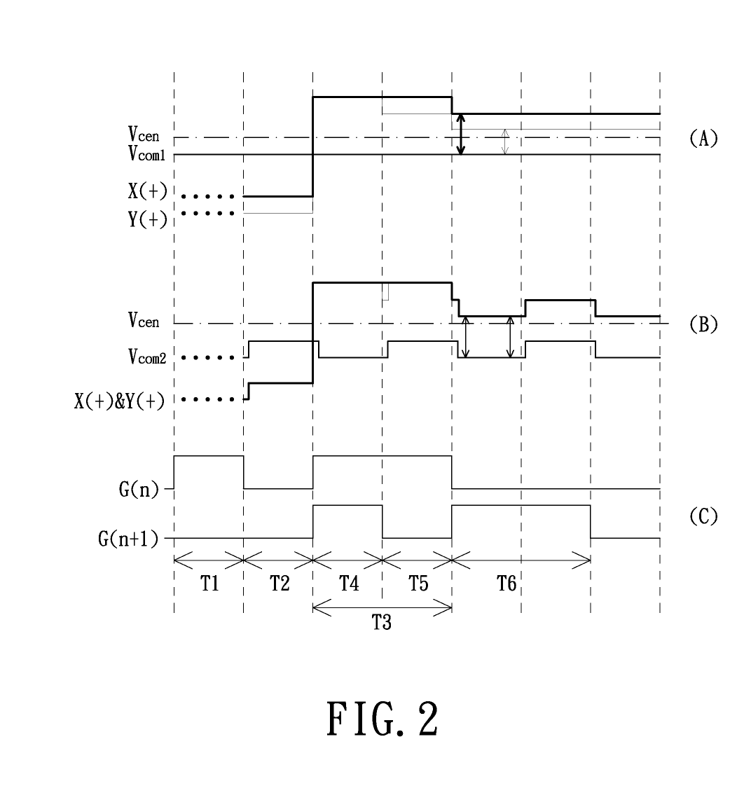

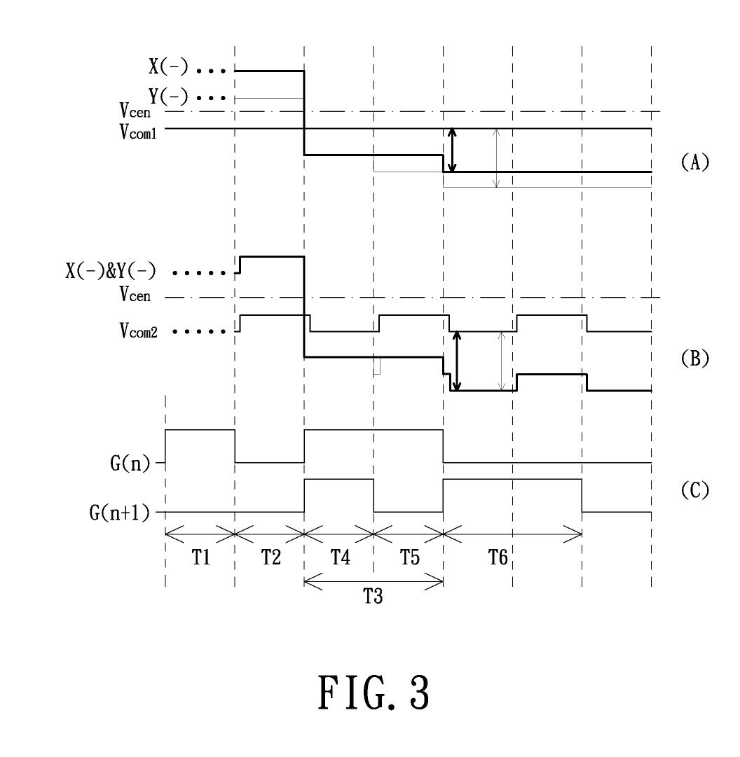

Referring to FIGS. 1(A), 1(B), 2 and 3, FIGS. 1(A) and 1(B) illustrate polarity arrangements of multiple pixels during a HSD display device with column inversion of a first embodiment of the present invention displaying a frame F1 and a frame F2, respectively, FIG. 2 illustrates DC common voltage driving processes during displaying the frame F1 in FIG. 1(A), and FIG. 3 illustrates DC common voltage driving processes during displaying the frame F2 in FIG. 1(B). Herein, the frames F1 and F2 respectively are an odd frame and an even frame sequentially displayed.

As illustrated in FIGS. 1(A) and 1(B), the HSD display device is adapted to receive display data from a signal source e.g., the system end (not shown) and includes multiple data lines e.g., S(m−1), S(m), S(m+1), multiple gate lines e.g., G(n−1), G(n), G(n+1), G(n+2), and multiple pixel sets, where m, n are positive integers. Each of the pixel sets includes a first pixel P1 and a second pixel P2. In one pixel set, the first pixel P1 is electrically coupled to one of the data lines (e.g., S(m−1)) and one of the gate lines (e.g., G(n)), the second pixel P2 is electrically coupled to the first pixel P1 to receive the display data from the data line S(m−1) and further electrically coupled to another one of the gate lines (e.g., G(n−1)). In this embodiment, for the convenience of description, one of the first pixels P1 and one of the second pixels P2 both electrically coupled to the data line S(m) and the gate line G(n) and respectively labeled as X and Y are taken as an example to illustrate the common voltage driving processes below in detail.

Referring to FIGS. 1(A) and 2 together, during displaying the frame F1, a polarity of the data voltage on the first pixel X and a polarity of the data voltage on the second pixel Y both are positive (+) (i.e., higher than the common voltage). FIG. 2(A) shows a conventional driving process of a DC common voltage Vcom1 only having one voltage level at a side of the data central voltage Vcen during displaying the frame F1, FIG. 2(B) shows another driving process of a DC common voltage Vcom2 having two different voltage levels at a same side of the data central voltage Vcen during displaying the frame F1, and FIG. 2(C) shows a timing diagram of gate driving pulse signals respectively on the gate lines G(n), G(n+1). In various embodiments of the present invention, the data central voltage Vcen is defined as an average value of data voltages with different polarities provided from the signal source for displaying a same gray level.

As illustrated in FIG. 2, in a time period T1, the gate line G(n) is enabled to turn on the second pixel Y. In a time period T2 immediately following the time period T1, the gate line G(n) is disabled to turn off the second pixel Y. In a former time period T4 of a time period T3 immediately following the time period T2, the gate lines G(n), G(n+1) both are enabled, the first pixel X and the second pixel Y simultaneously receive the display data from the data line S(m) and thereby are charged to a data voltage with positive polarity. In a latter time period T5 of the time period T3 immediately following the time period T4, the gate line G(n) is kept to be enabled while the gate line G(n+1) is disabled, the first pixel P1 connected between the second pixel Y and the data line S(m) is turned off because of the disabled gate line G(n+1), the second pixel Y is subjected to once feed through effect at the moment that the gate line G(n+1) is disabled and thereby the data voltage on the second pixel Y is slightly pulled down, as shown in FIG. 2(A). Afterwards, in a time period T6 immediately following the time period T3, the gate line G(n) is disabled while the gate line G(n+1) is enabled, the first pixel X and the second pixel Y both are subjected to once feed through effect at the moment that the gate line G(n) is disabled and thereby the data voltages on them both are slightly pulled down.

In short, the second pixel Y is subjected to twice feed through effect, while the first pixel X is only subjected to once feed through effect. Accordingly, in the prior art as illustrated in FIG. 2(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 2(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

In addition, it also can be found from FIG. 2 that, the time period T1 has a time length same as that of the time period T4, the time period T3 has a time length same as that of the time period T6, the time period T3 is equally divided into the time period T4 and the time period T5, and a switching period of the two different voltage levels of the common voltage Vcom2 at the same side of the data central voltage Vcen is equal to the time length of the time period T3, but they are not to limit the present invention.

Referring to FIGS. 1(B) and 3 together, during displaying the frame F2, a polarity of the data voltage on the first pixel X and a polarity of the data voltage on the second pixel Y both are negative (−) (i.e., lower than the common voltage). FIG. 3(A) shows a conventional driving process of the DC common voltage Vcom1 only having one voltage level at a side of the data central voltage Vcen during displaying the frame F2, FIG. 3(B) shows another driving process of the DC common voltage Vcom2 having two different voltage levels at a same side of the data central voltage Vcen during displaying the frame F2, and FIG. 3(C) shows a timing diagram of gate driving pulse signals respectively on the gate lines G(n), G(n+1).

As seen from FIG. 3, the second pixel Y is subjected to twice feed through effect, while the first pixel X is only subjected to once feed through effect. Accordingly, in the prior art as illustrated in FIG. 3(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 3(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Second Embodiment

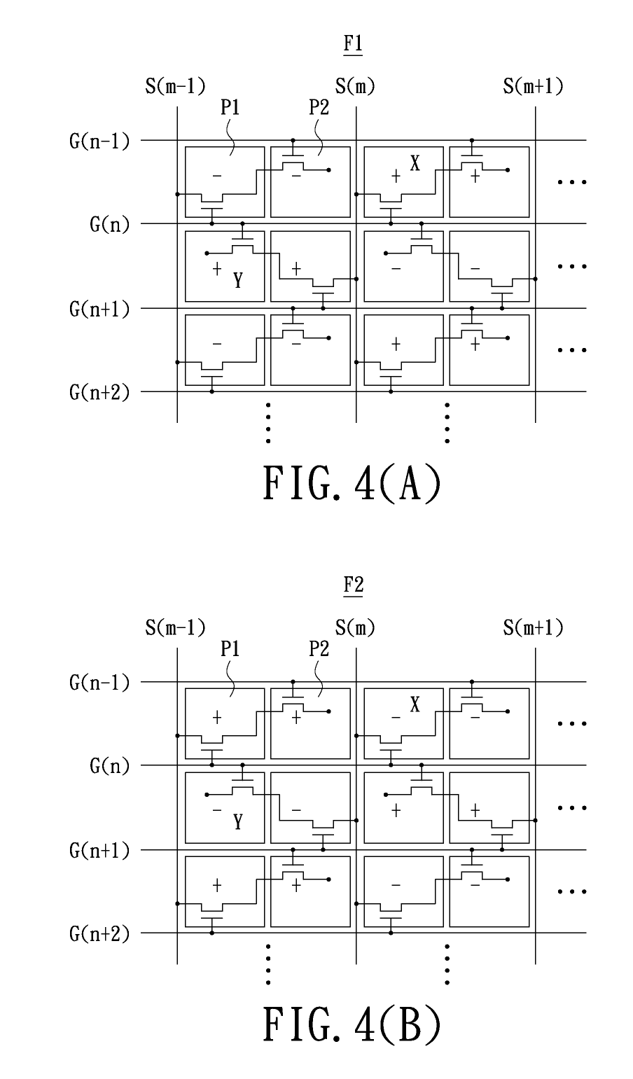

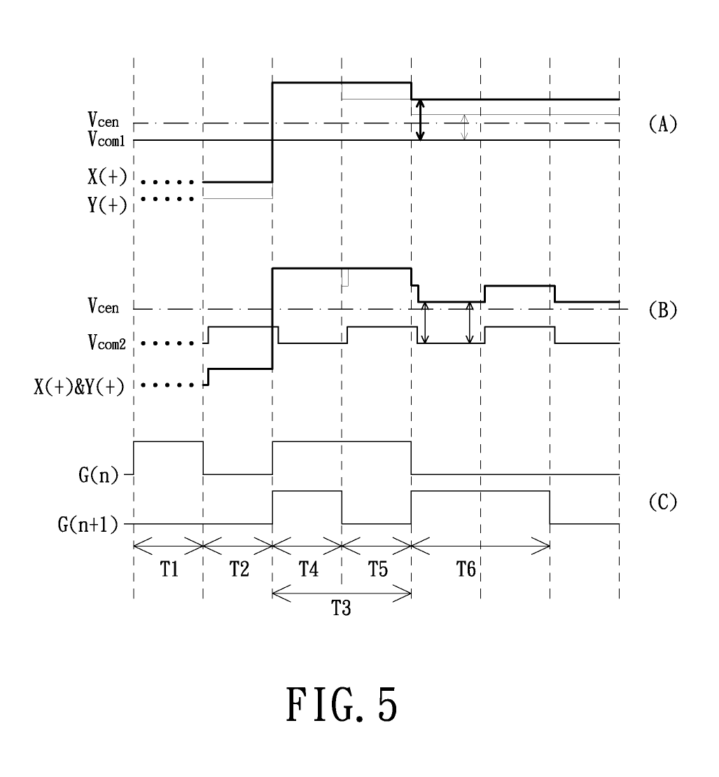

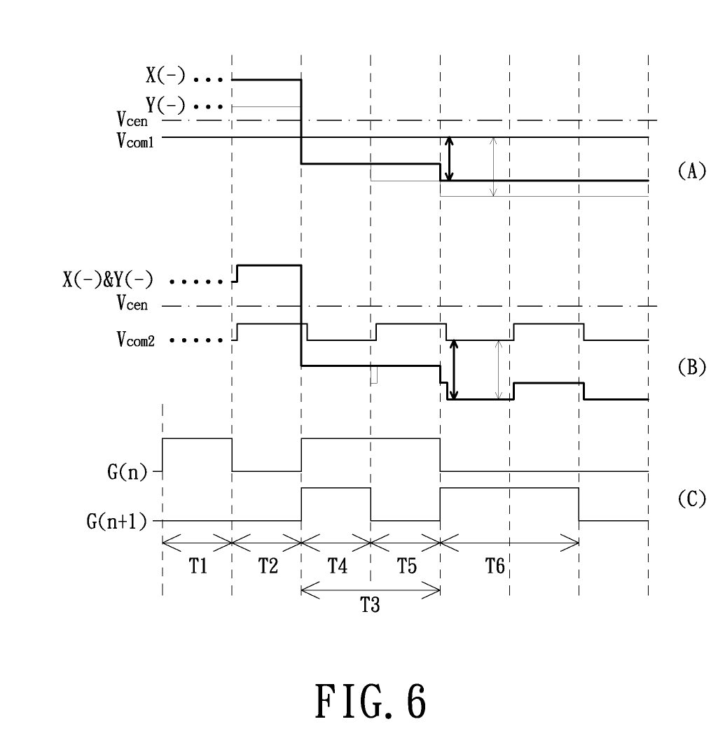

Referring to FIGS. 4(A), 4(B), 5 and 6, FIGS. 4(A) and 4(B) showing polarity arrangements of multiple pixels during a HSD display device with 2-dot inversion of a second embodiment of the present invention displaying a frame F1 and a frame F2, FIG. 5 showing DC common voltage driving processes during displaying the frame F1 in FIG. 4(A), and FIG. 6 showing DC common voltage driving processes during displaying the frame F2 in FIG. 4(B).

In the second embodiment, the structure of the HSD display device as illustrated in FIGS. 4(A) and 4(B) is similar to that of the HSD display device as illustrated in FIGS. 1(A) and 1(B), and thus will not be repeated herein. What is difference is that the HSD display device as illustrated in FIGS. 4(A) and 4(B) employs a 2-dot inversion manner rather than the column inversion manner, and therefore the polarity arrangements of pixels during displaying the frames F1, F2 are different from that as illustrated in FIGS. 1(A) and 1(B).

Referring to FIGS. 4(A) and 5 together, during displaying the frame F1, a polarity of the data voltage on the first pixel X and a polarity of the data voltage on the second pixel Y both are positive (+). FIG. 5(A) shows a conventional driving process of a DC common voltage Vcom1 only having one voltage level at a side of the data central voltage Vcen during displaying the frame F1, FIG. 5(B) shows another driving process of a DC common voltage Vcom2 having two different voltage levels at a same side of the data central voltage Vcen during displaying the frame F1, and FIG. 5(C) shows a timing diagram of gate driving pulse signals respectively on the gate lines G(n), G(n+1).

As seen from FIG. 5 that, the second pixel Y is subjected to twice feed through effect, while the first pixel X is only subjected to once feed through effect. Accordingly, in the prior art as illustrated in FIG. 5(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 5(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

Referring to FIGS. 4(B) and 6 together, during displaying the frame F2, a polarity of the data voltage on the first pixel X and a polarity of the data voltage on the second pixel Y both are negative (−). FIG. 6(A) shows a conventional driving process of the DC common voltage Vcom1 only having one voltage level at a side of the data central voltage Vcen during displaying the frame F2, FIG. 6(B) shows another driving process of the DC common voltage Vcom2 having two different voltage levels at a same side of the data central voltage Vcen during displaying the frame F2, and FIG. 6(C) shows a timing diagram of gate driving pulse signals respectively on the gate lines G(n), G(n+1).

As seen from FIG. 6 that, the second pixel Y is subjected to twice feed through effect, while the first pixel X is only subjected to once feed through effect. Accordingly, in the prior art as illustrated in FIG. 6(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 6(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Third Embodiment

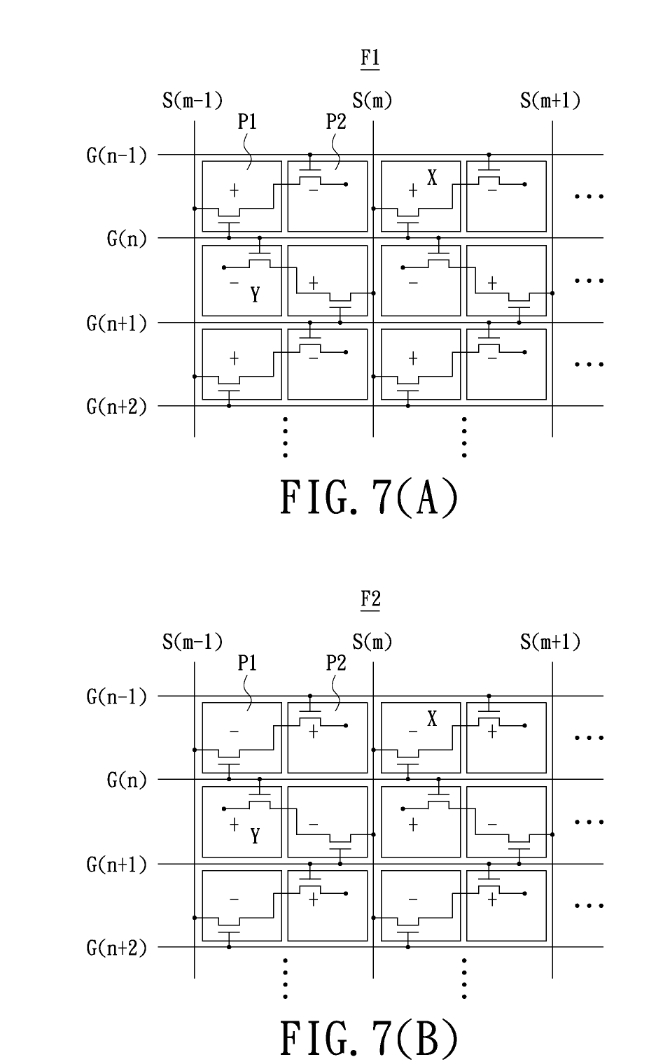

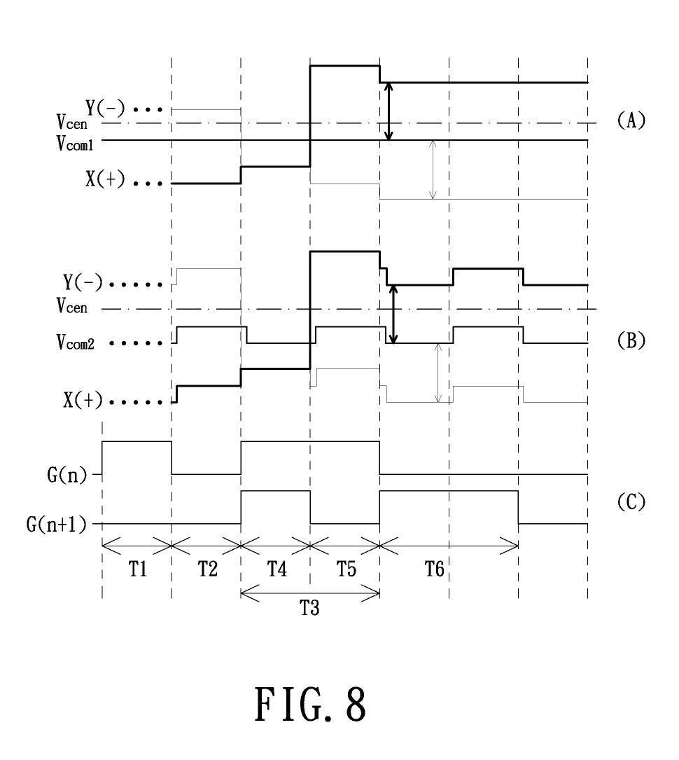

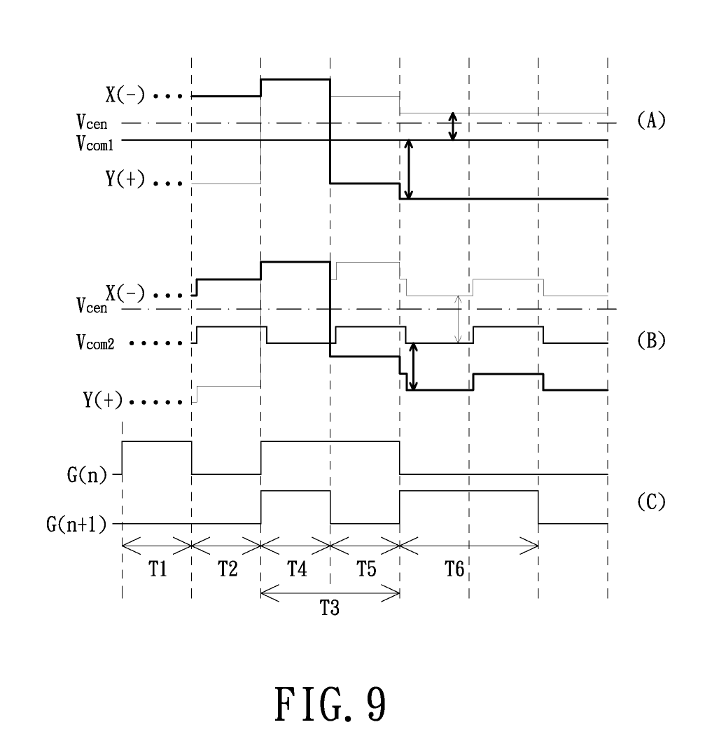

Referring to FIGS. 7(A), 7(B), 8 and 9, FIGS. 7(A) and 7(B) showing polarity arrangements of multiple pixels during a HSD display device with dot inversion of a third embodiment of the present invention displaying a frame F1 and a frame F2, FIG. 8 showing DC common voltage driving processes during displaying the frame F1 in FIG. 7(A), and FIG. 9 showing DC common voltage driving processes during displaying the frame F2 in FIG. 7(B).

In the third embodiment, the structure of the HSD display device as illustrated in FIGS. 7(A) and 7(B) is similar to that of the HSD display device as illustrated in FIGS. 1(A) and 1(B), and thus will not be repeated herein. What is difference is that the HSD display device as illustrated in FIGS. 7(A) and 7(B) employs a dot inversion manner rather than the column inversion manner, and therefore the polarity arrangements of pixels during displaying the frames F1, F2 are different from that as illustrated in FIGS. 1(A) and 1(B).

Referring to FIGS. 7(A) and 8 together, during displaying the frame F1, a polarity of the data voltage on the first pixel X is positive (+) while a polarity of the data voltage on the second pixel Y is negative (−). FIG. 8(A) shows a conventional driving process of a DC common voltage Vcom1 only having one voltage level at a side of the data central voltage Vcen during displaying the frame F1, FIG. 8(B) shows another driving process of a DC common voltage Vcom2 having two different voltage levels at a same side of the data central voltage Vcen during displaying the frame F1, and FIG. 8(C) shows a timing diagram of gate driving pulse signals respectively on the gate lines G(n), G(n+1).

As seen from FIG. 8 that, the second pixel Y is subjected to twice feed through effect, while the first pixel X is only subjected to once feed through effect. Accordingly, in the prior art as illustrated in FIG. 8(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 8(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

Referring to FIGS. 7(B) and 9 together, during displaying the frame F2, a polarity of the data voltage on the first pixel X is negative (−), while a polarity of the data voltage on the second pixel Y is positive (+). FIG. 9(A) shows a conventional driving process of the DC common voltage Vcom1 only having one voltage level at a side of the data central voltage Vcen during displaying the frame F2, FIG. 9(B) shows another driving process of the DC common voltage Vcom2 having two different voltage levels at a same side of the data central voltage Vcen during displaying the frame F2, and FIG. 9(C) shows a timing diagram of gate driving pulse signals respectively on the gate lines G(n), G(n+1).

As seen from FIG. 9 that, the second pixel Y is subjected to twice feed through effect, while the first pixel X is only subjected to once feed through effect. Accordingly, in the prior art as illustrated in FIG. 9(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 9(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Fourth Embodiment

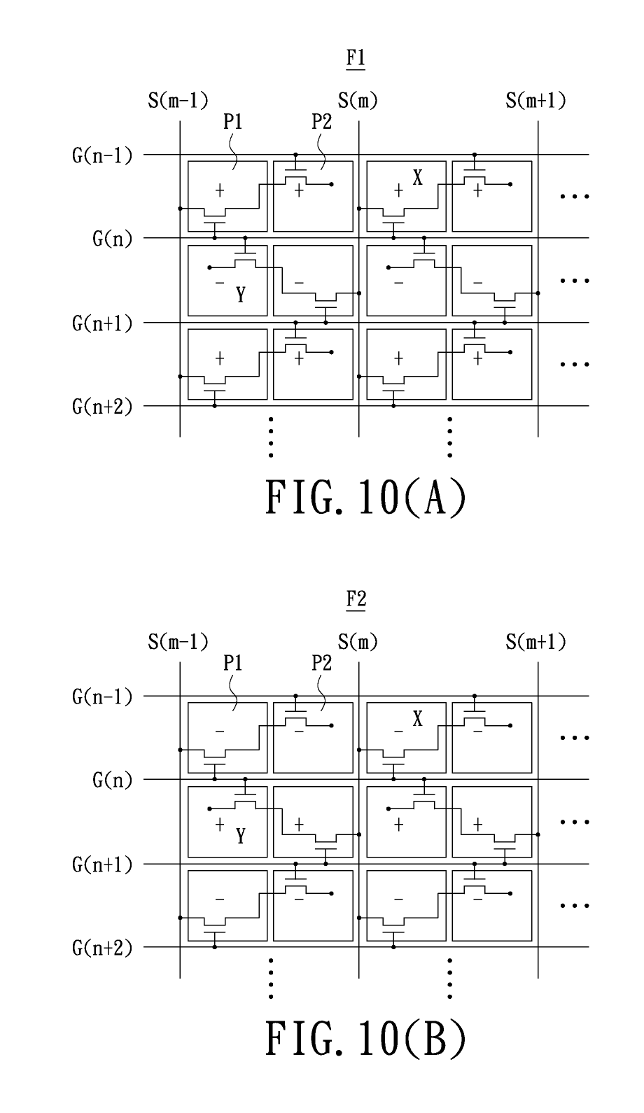

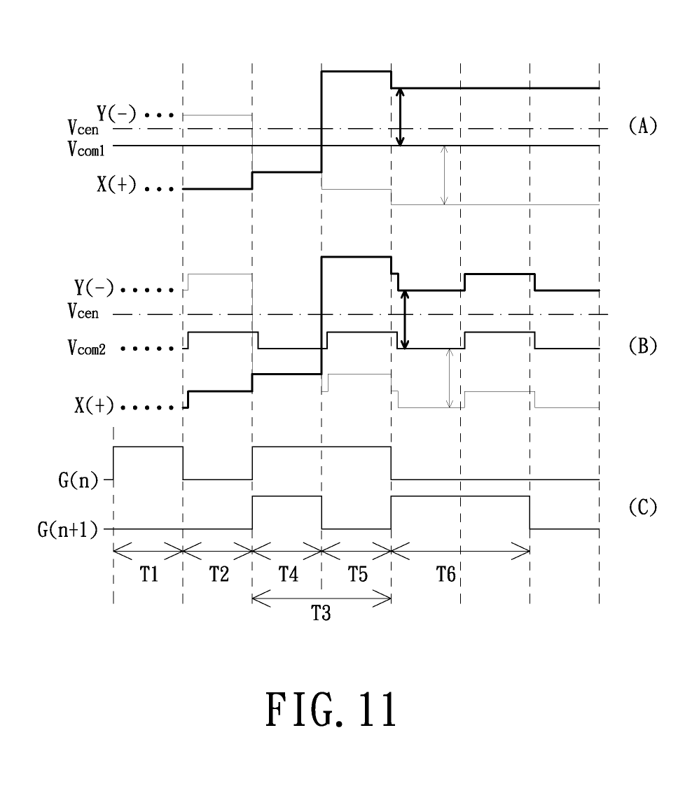

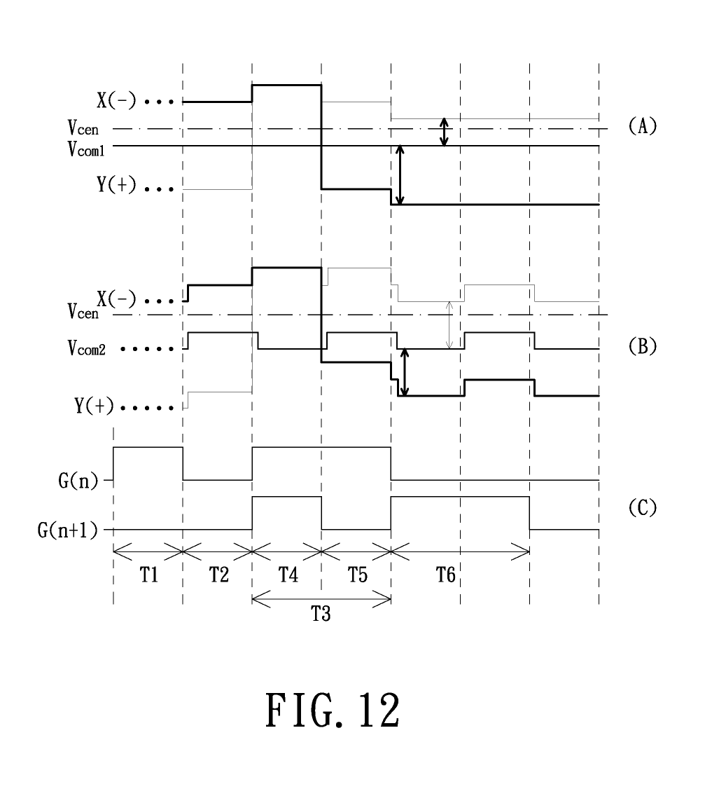

Referring to FIGS. 10(A), 10(B), 11 and 12, FIGS. 10(A) and 10(B) showing polarity arrangements of multiple pixels during a HSD display device with row inversion of a fourth embodiment of the present invention displaying a frame F1 and a frame F2, FIG. 11 showing DC common voltage driving processes during displaying the frame F1 in FIG. 10(A), and FIG. 12 showing DC common voltage driving processes during displaying the frame F2 in FIG. 10(B).

In the fourth embodiment, the structure of the HSD display device as illustrated in FIGS. 10(A) and 10(B) is similar to that of the HSD display device as illustrated in FIGS. 1(A) and 1(B), and thus will not be repeated herein. What is difference is that the HSD display device as illustrated in FIGS. 10(A) and 10(B) employs a row inversion manner rather than the column inversion manner, and therefore the polarity arrangements of pixels during displaying the frames F1, F2 are different from that as illustrated in FIGS. 1(A) and 1(B).

Referring to FIGS. 10(A) and 11 together, during displaying the frame F1, a polarity of the data voltage on the first pixel X is positive (+), while a polarity of the data voltage on the second pixel Y is negative (−). FIG. 11(A) shows a conventional driving process of a DC common voltage Vcom1 only having one voltage level at a side of the data central voltage Vcen during displaying the frame F1, FIG. 11(B) shows another driving process of a DC common voltage Vcom2 having two different voltage levels at a same side of the data central voltage Vcen during displaying the frame F1, and FIG. 11(C) shows a timing diagram of gate driving pulse signals respectively on the gate lines G(n), G(n+1).

As seen from FIG. 11 that, the second pixel Y is subjected to twice feed through effect, while the first pixel X is only subjected to once feed through effect. Accordingly, in the prior art as illustrated in FIG. 11(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 11(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

Referring to FIGS. 10(B) and 12 together, during displaying the frame F2, a polarity of the data voltage on the first pixel X is negative (−), while a polarity of the data voltage on the second pixel Y is positive (+). FIG. 12(A) shows a conventional driving process of the DC common voltage Vcom1 only having one voltage level at a side of the data central voltage Vcen during displaying the frame F2, FIG. 12(B) shows another driving process of the DC common voltage Vcom2 having two different voltage levels at a same side of the data central voltage Vcen during displaying the frame F2, and FIG. 12(C) shows a timing diagram of gate driving pulse signals respectively on the gate lines G(n), G(n+1).

As seen from FIG. 12 that, the second pixel Y is subjected to twice feed through effect, while the first pixel X is only subjected to once feed through effect. Accordingly, in the prior art as illustrated in FIG. 12(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 12(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Fifth Embodiment

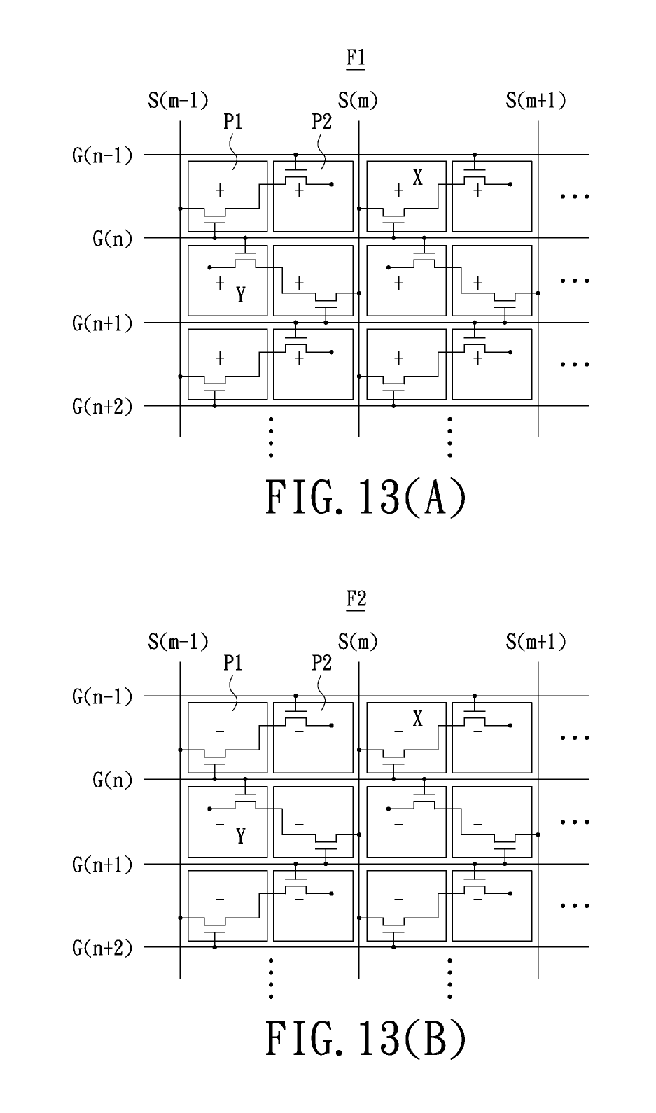

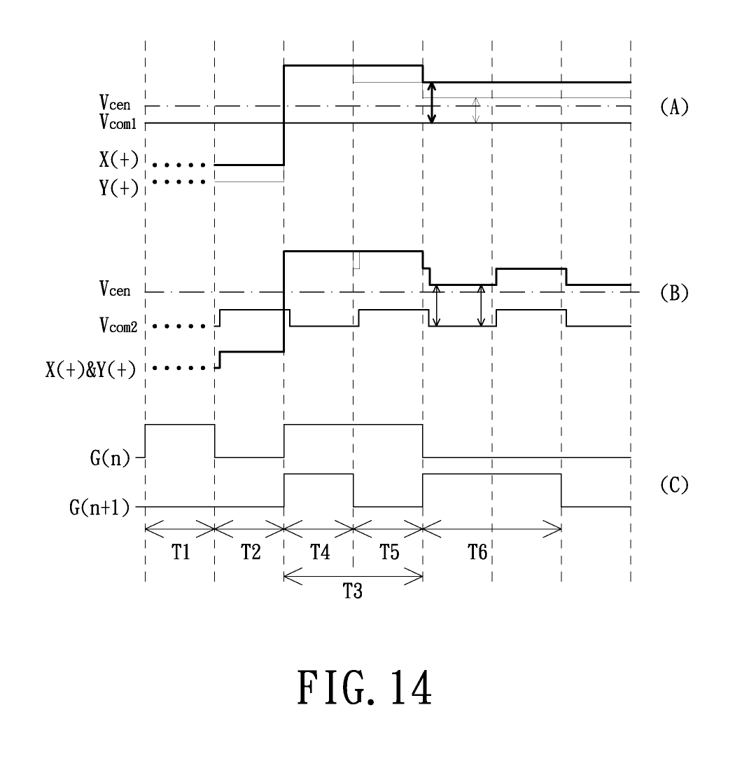

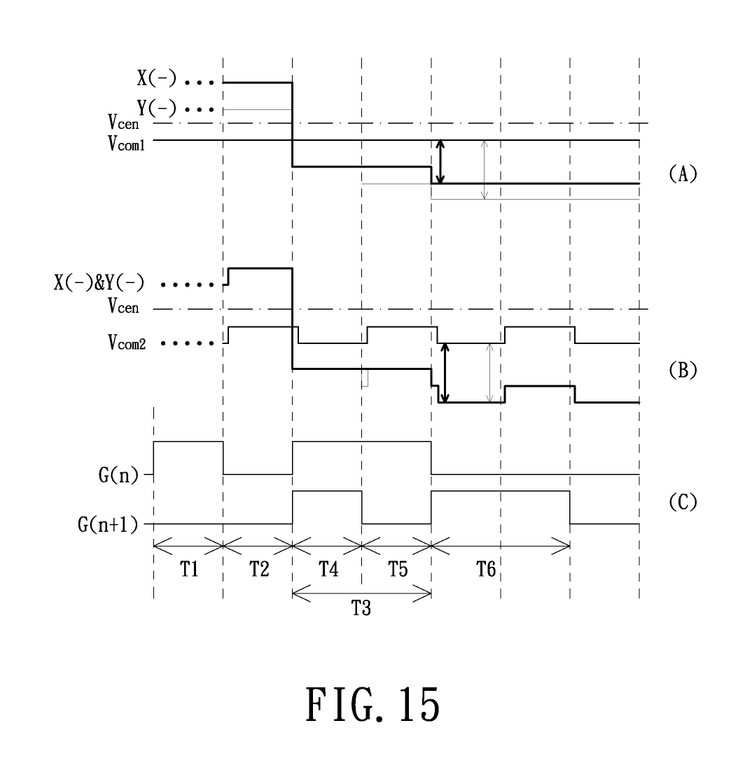

Referring to FIGS. 13(A), 13(B), 14 and 15, FIGS. 13(A) and 13(B) showing polarity arrangements of multiple pixels during a HSD display device with frame inversion of a fifth embodiment of the present invention displaying a frame F1 and a frame F2, FIG. 14 showing DC common voltage driving processes during displaying the frame F1 in FIG. 13(A), and FIG. 15 showing DC common voltage driving processes during displaying the frame F2 in FIG. 13(B).

In the fifth embodiment, the structure of the HSD display device as illustrated in FIGS. 13(A) and 13(B) is similar to that of the HSD display device as illustrated in FIGS. 1(A) and 1(B), and thus will not be repeated herein. What is difference is that the HSD display device as illustrated in FIGS. 13(A) and 13(B) employs a frame inversion manner rather than the column inversion manner, and therefore the polarity arrangements of pixels during displaying the frames F1, F2 are different from that as illustrated in FIGS. 1(A) and 1(B).

Referring to FIGS. 13(A) and 14 together, during displaying the frame F1, a polarity of the data voltage on the first pixel X and a polarity of the data voltage on the second pixel Y both are positive (+). FIG. 14(A) shows a conventional driving process of a DC common voltage Vcom1 only having one voltage level at a side of the data central voltage Vcen during displaying the frame F1, FIG. 14(B) shows another driving process of a DC common voltage Vcom2 having two different voltage levels at a same side of the data central voltage Vcen during displaying the frame F1, and FIG. 14(C) shows a timing diagram of gate driving pulse signals respectively on the gate lines G(n), G(n+1).

As seen from FIG. 14 that, the second pixel Y is subjected to twice feed through effect, while the first pixel X is only subjected to once feed through effect. Accordingly, in the prior art as illustrated in FIG. 14(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 14(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

Referring to FIGS. 13(B) and 15 together, during displaying the frame F2, a polarity of the data voltage on the first pixel X and a polarity of the data voltage on the second pixel Y both are negative (−). FIG. 15(A) shows a conventional driving process of the DC common voltage Vcom1 only having one voltage level at a side of the data central voltage Vcen during displaying the frame F2, FIG. 15(B) shows another driving process of the DC common voltage Vcom2 having two different voltage levels at a same side of the data central voltage Vcen during displaying the frame F2, and FIG. 15(C) shows a timing diagram of gate driving pulse signals respectively on the gate lines G(n), G(n+1).

As seen from FIG. 15 that, the second pixel Y is subjected to twice feed through effect, while the first pixel X is only subjected to once feed through effect. Accordingly, in the prior art as illustrated in FIG. 15(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 15(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Sixth Embodiment

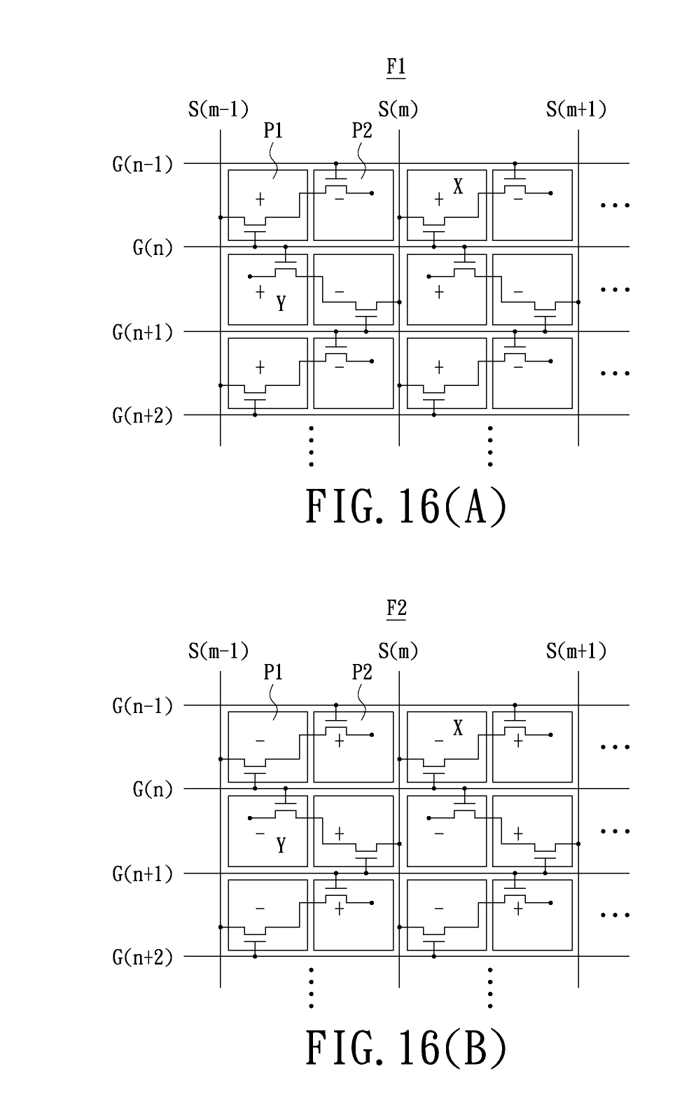

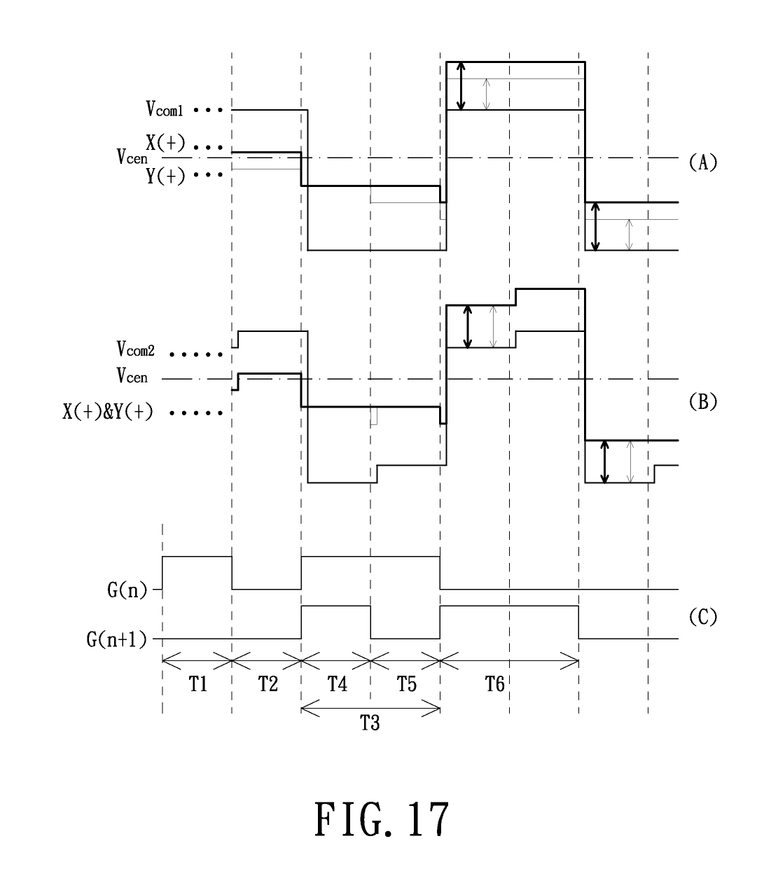

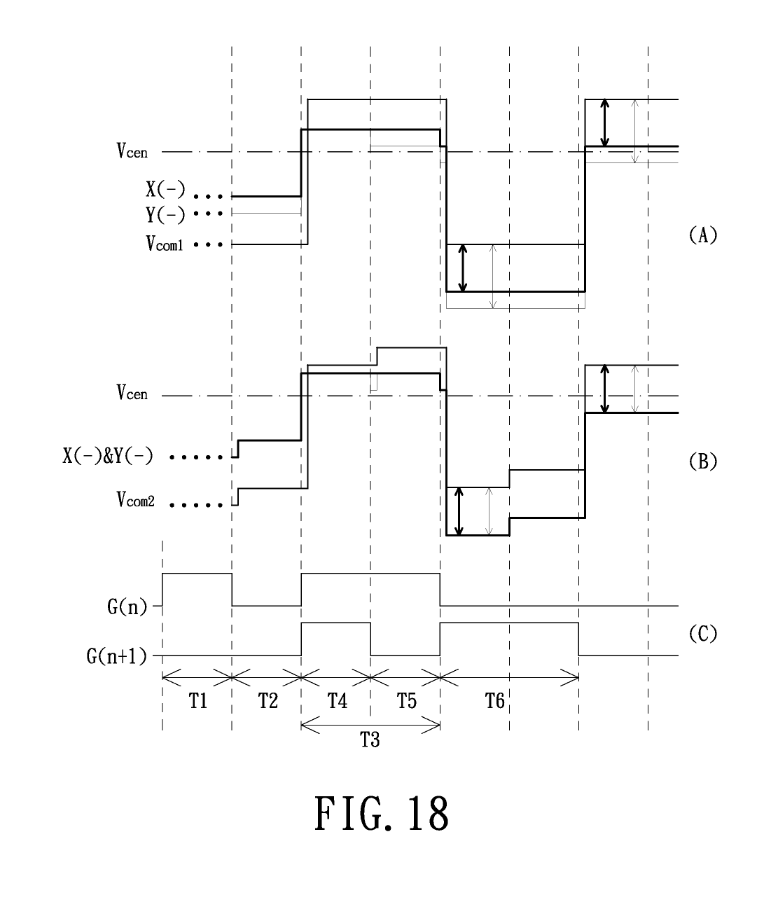

Referring to FIGS. 16(A), 16(B), 17 and 18, FIGS. 16(A) and 16(B) showing polarity arrangements of multiple pixels during a HSD display device with column inversion of a sixth embodiment of the present invention displaying a frame F1 and a frame F2, FIG. 17 showing AC common voltage driving processes during displaying the frame F1 in FIG. 16(A), and FIG. 18 showing AC common voltage driving processes during displaying the frame F2 in FIG. 16(B).

In the sixth embodiment, the structure of the HSD display device as illustrated in FIGS. 16(A) and 16(B) is similar to that of the HSD display device as illustrated in FIGS. 1(A) and 1(B), and thus will not be repeated herein. What is difference is that the HSD display device as illustrated in FIGS. 16(A) and 16(B) employs an AC common voltage rather than the DC common voltage to drive the pixels.

Referring to FIGS. 16(A) and 17 together, during displaying the frame F1, a polarity of the data voltage on the first pixel X and a polarity of the data voltage on the second pixel Y both are positive (+). FIG. 17(A) shows a conventional driving process of an AC common voltage Vcom1 only having one voltage level at each side of the data central voltage Vcen during displaying the frame F1, FIG. 17(B) shows another driving process of an AC common voltage Vcom2 having two different voltage levels at each side of the data central voltage Vcen during displaying the frame F1, and FIG. 17(C) shows a timing diagram of gate driving pulse signals respectively on the gate lines G(n), G(n+1). Herein, the AC common voltages Vcom1, Vcom2 each go back and forth at two sides of the data central voltage Vcen.

As seen from FIG. 17 that, the second pixel Y is subjected to twice feed through effect, while the first pixel X is only subjected to once feed through effect. Accordingly, in the prior art as illustrated in FIG. 17(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 17(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

Referring to FIGS. 16(B) and 18 together, during displaying the frame F2, a polarity of the data voltage on the first pixel X and a polarity of the data voltage on the second pixel Y both are negative (−). FIG. 18(A) shows a conventional driving process of the AC common voltage Vcom1 only having one voltage level at each side of the data central voltage Vcen during displaying the frame F2, FIG. 18(B) shows another driving process of the AC common voltage Vcom2 having two different voltage levels at each side of the data central voltage Vcen during displaying the frame F2, and FIG. 18(C) shows a timing diagram of gate driving pulse signals respectively on the gate lines G(n), G(n+1).

As seen from FIG. 18 that, the second pixel Y is subjected to twice feed through effect, while the first pixel X is only subjected to once feed through effect. Accordingly, in the prior art as illustrated in FIG. 18(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 18(B), since the common voltage Vcom2 in the time period T5 is slightly pulled up, the first feed through effect applied to the second pixel Y is compensated by capacitive coupling effect, so that the data voltage on the second pixel Y in the time period T5 is retrieved to its original value (i.e., the data voltage before being pulled down caused by the first feed through effect) owing to the compensation effect of the common voltage Vcom2.

### Seventh Embodiment

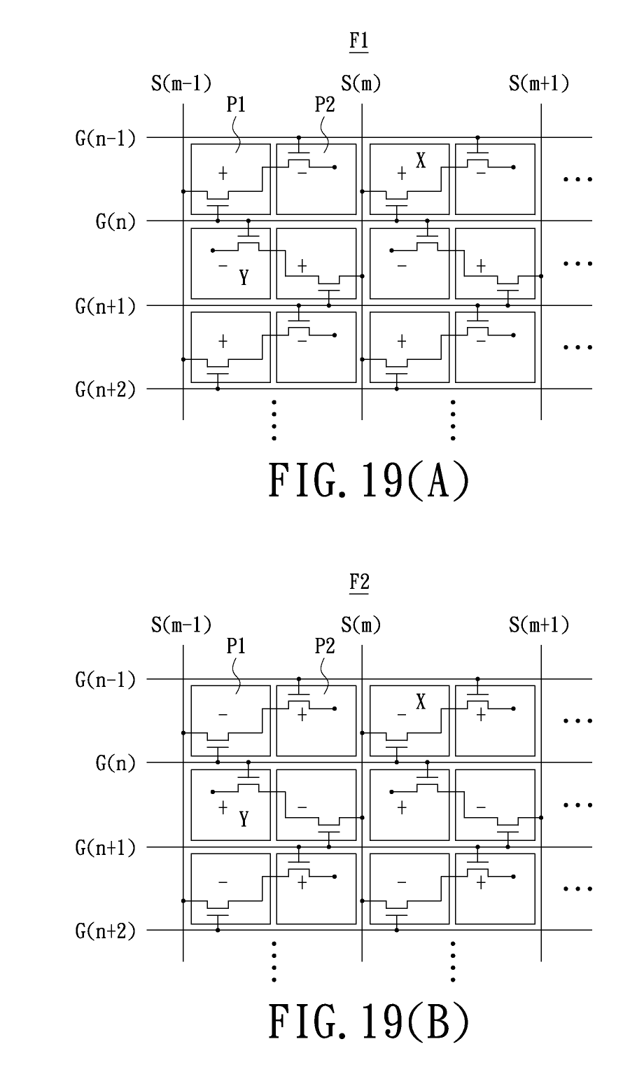

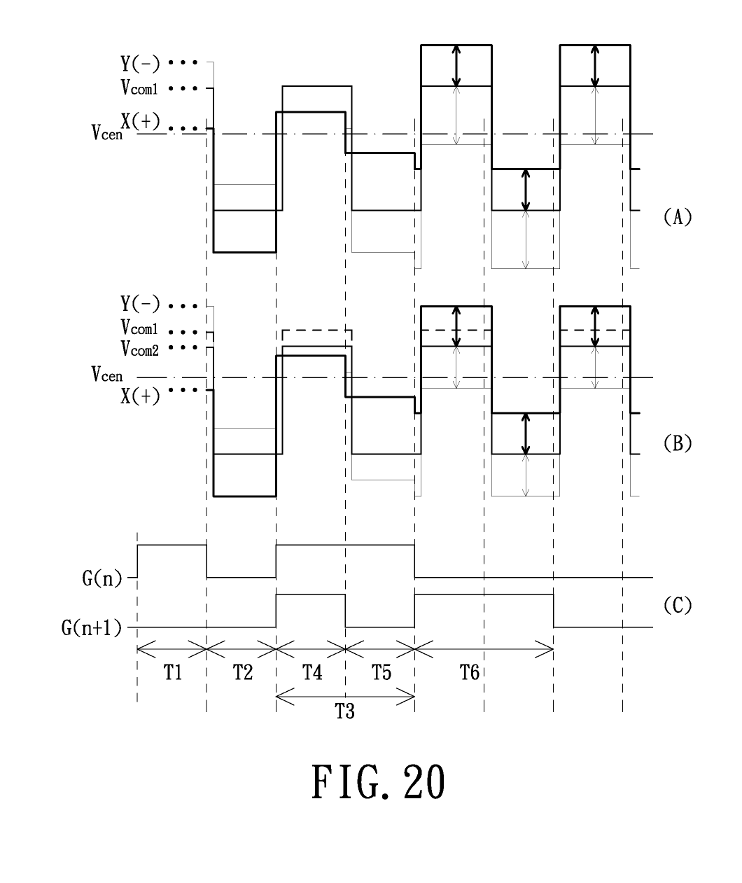

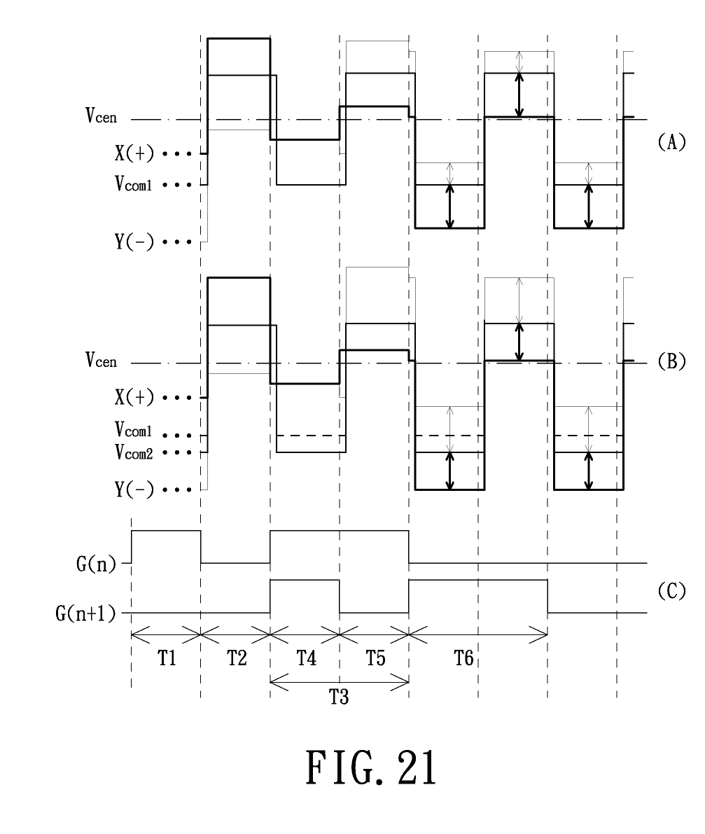

Referring to FIGS. 19(A), 19(B), 20 and 21, FIGS. 19(A) and 19(B) showing polarity arrangements of multiple pixels during a HSD display device with dot inversion of a seventh embodiment of the present invention displaying a frame F1 and a frame F2, FIG. 20 showing AC common voltage driving processes during displaying the frame F1 in FIG. 19(A), and FIG. 21 showing AC common voltage driving processes during displaying the frame F2 in FIG. 19(B).

In the seventh embodiment, the structure of the HSD display device as illustrated in FIGS. 19(A) and 19(B) is similar to that of the HSD display device as illustrated in FIGS. 1(A) and 1(B), and thus will not be repeated herein. What is difference is that the HSD display device as illustrated in FIGS. 19(A) and 19(B) employs a dot inversion manner rather than the column inversion manner, and therefore the polarity arrangements of pixels during displaying the frames F1, F2 are different from that as illustrated in FIGS. 1(A) and 1(B); and furthermore the HSD display device as illustrated in FIGS. 19(A) and 19(B) employs an AC common voltage rather than the DC common voltage to drive the pixels.

Referring to FIGS. 19(A) and 20 together, during displaying the frame F1, a polarity of the data voltage on the first pixel X is positive (+), while a polarity of the data voltage on the second pixel Y is negative (−). FIG. 20(A) shows a conventional driving process of an AC common voltage Vcom1 only having one voltage level at each side of the data central voltage Vcen during displaying the frame F1, FIG. 20(B) shows another driving process of an AC common voltage Vcom2 having one voltage level at each side of the data central voltage Vcen during displaying the frame F1, and FIG. 20(C) shows a timing diagram of gate driving pulse signals respectively on the gate lines G(n), G(n+1).

As seen from FIG. 20 that, the second pixel Y is subjected to twice feed through effect, while the first pixel X is only subjected to once feed through effect. Accordingly, in the prior art as illustrated in FIG. 20(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 20(B), since a voltage level of the AC common voltage Vcom2 in the time period T4 higher than the data central voltage Vcen is lower than the corresponding voltage level of the AC common voltage Vcom1, while a voltage level of the AC common voltage Vcom2 in the time period T5 lower than the data central voltage Vcen is equal to the corresponding voltage level of AC common voltage Vcom1, so that the pulled-down amount of the AC common voltage Vcom2 in the time period T5 is relatively less and thus the data voltage on the second pixel Y in the time period T5 is pulled down less correspondingly. As a result, the first feed through effect applied to the second pixel Y can be compensated by the AC common voltage Vcom2.

Referring to FIGS. 19(A) and 21 together, during displaying the frame F2, a polarity of the data voltage on the first pixel X is negative (−), while a polarity of the data voltage on the second pixel Y is positive (+). FIG. 21(A) shows a conventional driving process of an AC common voltage Vcom1 only having one voltage level at each side of the data central voltage Vcen during displaying the frame F1, FIG. 21(B) shows another driving process of an AC common voltage Vcom2 having one voltage level at each side of the data central voltage Vcen during displaying the frame F1, and FIG. 21(C) shows a timing diagram of gate driving pulse signals respectively on the gate lines G(n), G(n+1).

As seen from FIG. 21 that, the second pixel Y is subjected to twice feed through effect, while the first pixel X is only subjected to once feed through effect. Accordingly, in the prior art as illustrated in FIG. 21(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 21(B), since a voltage level of the AC common voltage Vcom2 in the time period T4 lower than the data central voltage Vcen is lower than the corresponding voltage level of the AC common voltage Vcom1, while a voltage level of the AC common voltage Vcom2 in the time period T5 higher than the data central voltage Vcen is equal to the corresponding voltage level of AC common voltage Vcom1, so that the pulled-up amount of the AC common voltage Vcom2 in the time period T5 is relatively more and thus the data voltage on the second pixel Y in the time period T5 is pulled down more correspondingly. As a result, the first feed through effect applied to the second pixel Y can be compensated by the AC common voltage Vcom2.

It is indicated that, in the seventh embodiment, although the AC common voltage Vcom2 as illustrated in FIG. 20(B) during displaying the frame F1 only has one voltage level in each side of the data central voltage Vcen, and the AC common voltage Vcom2 as illustrated in FIG. 21(B) during displaying the frame F2 also only has one voltage level in each side of the data central voltage Vcen; the voltage level of the AC common voltage Vcom2 in FIG. 20(B) higher than the data central voltage Vcen is lower than the corresponding voltage level of the AC common voltage Vcom1, the voltage level of the AC common voltage Vcom2 in FIG. 21(B) higher than the data central voltage Vcen is equal to the corresponding voltage level of the AC common voltage Vcom1. Similarly, the voltage level of the AC common voltage Vcom2 in FIG. 20(B) lower than the data central voltage Vcen is equal to the corresponding voltage level of the AC common voltage Vcom1, and the voltage level of the AC common voltage Vcom2 in FIG. 21(B) lower than the data central voltage Vcen is lower than the corresponding voltage level of the AC common voltage Vcom1. In other words, during continuously displaying the two adjacent frames F1, F2, the AC common voltage Vcom2 still has two different voltage levels at each side of the data central voltage Vcen.

### Eighth Embodiment

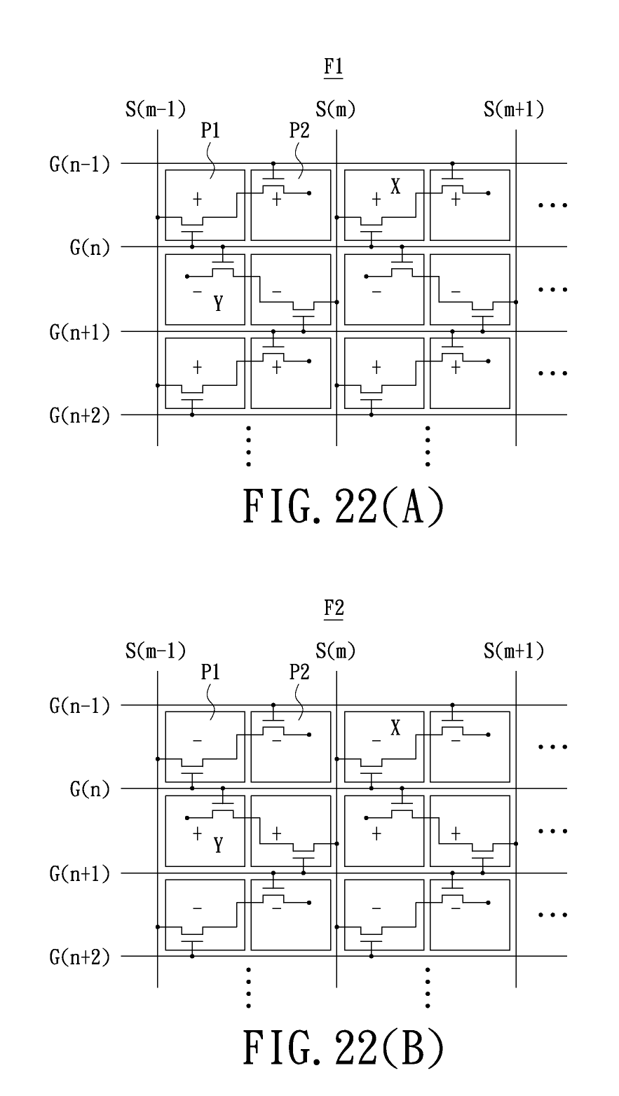

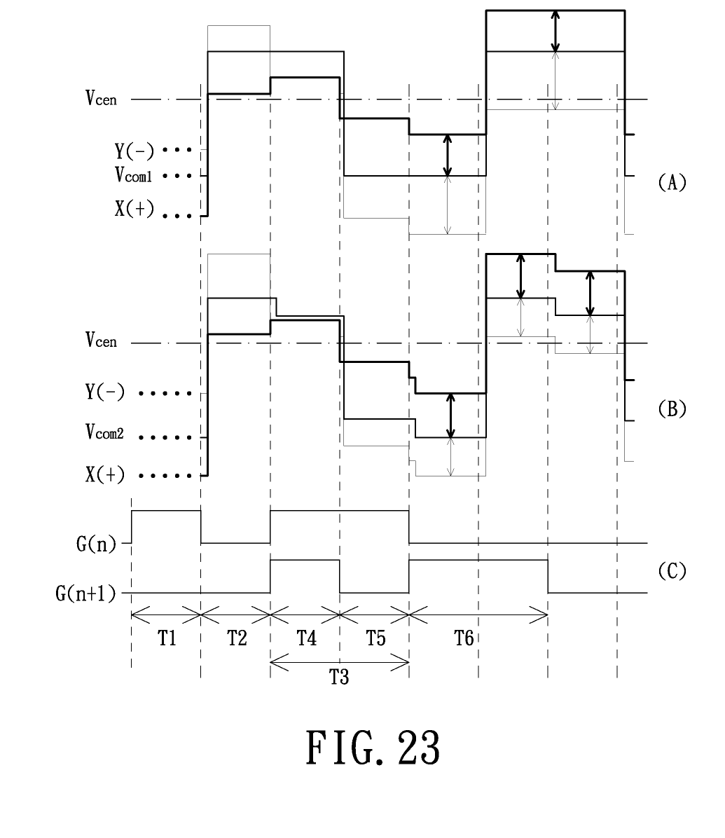

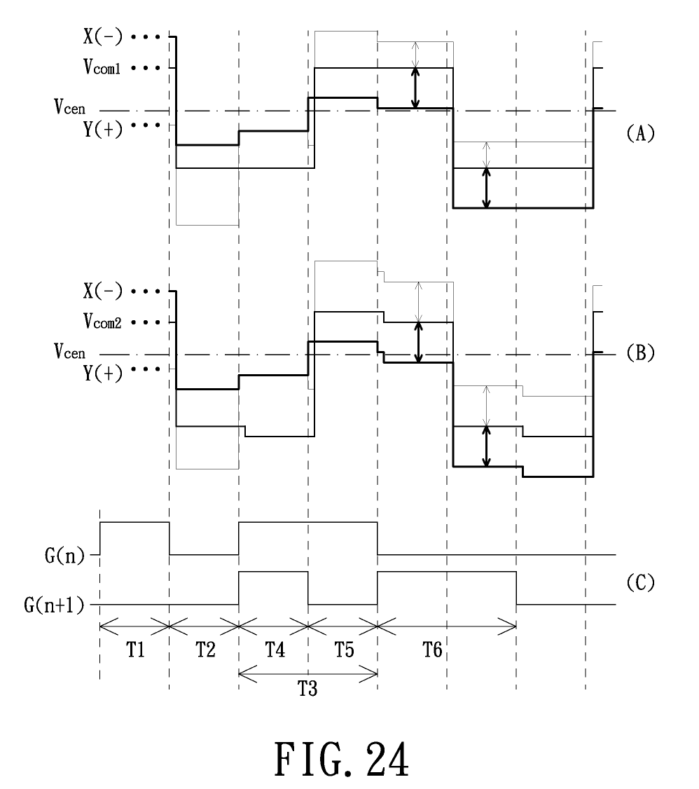

Referring to FIGS. 22(A), 22(B), 23 and 24, FIGS. 22(A) and 22(B) showing polarity arrangements of multiple pixels during a HSD display device with row inversion of a sixth embodiment of the present invention displaying a frame F1 and a frame F2, FIG. 23 showing AC common voltage driving processes during displaying the frame F1 in FIG. 22(A), and FIG. 24 showing AC common voltage driving processes during displaying the frame F2 in FIG. 22(B).

In the eighth embodiment, the structure of the HSD display device as illustrated in FIGS. 22(A) and 22(B) is similar to that of the HSD display device as illustrated in FIGS. 1(A) and 1(B), and thus will not be repeated herein. What is difference is that the HSD display device as illustrated in FIGS. 22(A) and 22(B) employs a row inversion manner rather than the column inversion manner, and therefore the polarity arrangements of pixels during displaying the frames F1, F2 are different from that as illustrated in FIGS. 1(A) and 1(B); and furthermore the HSD display device as illustrated in FIGS. 22(A) and 22(B) employs an AC common voltage rather than the DC common voltage to drive the pixels.

Referring to FIGS. 22(A) and 23 together, during displaying the frame F1, a polarity of the data voltage on the first pixel X is positive (+), while a polarity of the data voltage on the second pixel Y is negative (−). FIG. 23(A) shows a conventional driving process of an AC common voltage Vcom1 only having one voltage level at each side of the data central voltage Vcen during displaying the frame F1, FIG. 23(B) shows another driving process of an AC common voltage Vcom2 having two different voltage levels at each side of the data central voltage Vcen during displaying the frame F1, and FIG. 23(C) shows a timing diagram of gate driving pulse signals respectively on the gate lines G(n), G(n+1).

As seen from FIG. 23 that, the second pixel Y is subjected to twice feed through effect, while the first pixel X is only subjected to once feed through effect. Accordingly, in the prior art as illustrated in FIG. 23(A), the absolute value of a voltage difference between the resultant data voltage on the second pixel Y and the common voltage Vcom1 is larger than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 23(B), since the voltage level of the AC common voltage Vcom2 in the time period T4 is lower than that of the AC common voltage Vcom1 in FIG. 23(A), while the voltage level of the AC common voltage Vcom2 in the time period T5 is equal to that of the AC common voltage Vcom1 in FIG. 23(A), so that the pulled-down amount of the AC common voltage Vcom2 in the time period T5 is relatively less and the data voltage on the second pixel Y in the time period T5 is pulled down less correspondingly. As a result, the first feed through effect applied to the second pixel Y can be compensated by the AC common voltage Vcom2.

Referring to FIGS. 22(B) and 24 together, during displaying the frame F2, a polarity of the data voltage on the first pixel X is negative (−), while a polarity of the data voltage on the second pixel Y is positive (+). FIG. 24(A) shows a conventional driving process of an AC common voltage Vcom1 only having one voltage level at each side of the data central voltage Vcen during displaying the frame F1, FIG. 24(B) shows another driving process of an AC common voltage Vcom2 having two different voltage levels at each side of the data central voltage Vcen during displaying the frame F1, and FIG. 24(C) shows a timing diagram of gate driving pulse signals respectively on the gate lines G(n), G(n+1).

As seen from FIG. 24 that, the second pixel Y is subjected to twice feed through effect, while the first pixel X is only subjected to once feed through effect. Accordingly, in the prior art as illustrated in FIG. 24(A), the absolute value of a voltage difference between the resultant data voltage on the second pixel Y and the common voltage Vcom1 is smaller than the absolute value of another voltage difference between the resultant data voltage on the first pixel X and the common voltage Vcom1, which would result in the display brightnesses of the second pixel Y and the first pixel X respectively are different and thereby the dynamic mura phenomenon occurs. However, in the present embodiment as illustrated in FIG. 24(B), since the voltage level of the AC common voltage Vcom2 in the time period T4 is lower than that of the AC common voltage Vcom1 in FIG. 24(A), while the voltage level of the AC common voltage Vcom2 in the time period T5 is equal to that of the AC common voltage Vcom1 in FIG. 24(A), so that the pulled-up amount of the AC common voltage Vcom2 in the time period T5 is relatively more and the data voltage on the second pixel Y in the time period T5 is pulled up more correspondingly. As a result, the first feed through effect applied to the second pixel Y can be compensated by the AC common voltage Vcom2.

Sum up, in the various embodiments of the present invention, by enabling the DC or AC common voltage to have two different voltage levels at a same side of the data central voltage to thereby compensate the extra feed through effect applied to the second pixel, so that the feed through voltage of the second pixel in the present invention is substantially equal to the feed through voltage of the first pixel. Accordingly, the occurrence of dynamic mura phenomenon during the HSD display device displaying images in the prior art can be effectively suppressed.

Additionally, it is understood to the skilled person in the art that, the above embodiments of the present invention only take each pixel sets having two pixels connected in series as an example to describe the solution of using two-step common voltage levels at a same side of the data central voltage to compensate the dynamic mura, but the present invention is not limited to such example, for instance, with regard to a display device of which a single pixel sets having much more (e.g., three even more) pixels connected in series, multi-step (e.g., three even more step) common voltage levels can be set at a same side of the data central voltage, according to the inventive conception, to compensate the dynamic mura.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving method of a half-source-driving display device, the half-source-driving display device being adapted to receive data from a signal source and comprising a plurality of pixel sets, each of the pixel sets comprising a first pixel and a second pixel, the first pixel being electrically coupled to a first data line and a first gate line, the second pixel being electrically coupled to the first pixel and a second gate line, the first gate line being for controlling the first pixel whether to receive the data, and the second gate line being for controlling the second pixel whether to receive the data, the driving method comprising:
providing a common voltage to the first pixel and the second pixel; and
modulating the common voltage to have two different voltage levels at a same side of a data central voltage, wherein the data central voltage is an average value of data voltages with different polarities provided from the signal source for displaying a same gray level.

2. The driving method according to claim 1, wherein the common voltage is kept at one side of the data central voltage.

3. The driving method according to claim 1, wherein the common voltage goes back and forth at two sides of the data central voltage.

4. The driving method according to claim 3, wherein the common voltage has the two different voltage levels at each side of the data central voltage during the half-source-driving display device displaying a single frame.

5. The driving method according to claim 3, wherein the common voltage has the two different voltage levels at each side of the data central voltage during the half-source-driving display device continuously displaying a plurality of frames, but the common voltage only has one of the two different voltage levels at each side of the data central voltage during displaying any one of the frames.

6. The driving method according to claim 1, further comprising:
enabling the second gate line in a first time period;
disabling the second gate line in a second time period immediately following the first time period;
enabling the second gate line in a third time period immediately following the second time period;
enabling the first gate line in a former fourth time period of the third time period;
disabling the first gate line in a latter fifth time period of the third time period immediately following the fourth time period; and
enabling the first gate line in a sixth time period immediately following the third time period.

7. The driving method according to claim 6, wherein the first time period has a time length same as that of the fourth time period.

8. The driving method according to claim 6, wherein the third time period is equally divided into the fourth time period and the fifth time period.

9. The driving method according to claim 6, wherein the third time period has a time length same as that of the sixth time period.

10. The driving method according to claim 6, wherein during modulating the common voltage to have two different voltage levels at a same side of a data central voltage, a switching period of the two different voltage levels is the same as a time length of the third time period.
